(19) United States
(12) Patent Application Publication
(10) Pub. No.: US 2024/0073802 A1
(43) Pub. Date: Feb. 29, 2024

(54) REPORTING A NETWORK SLICE PARAMETER FOR ADMISSION CONTROL

(71) Applicant: Lenovo (Singapore) Pte. Ltd., New Tech Park (SG)

(72) Inventors: Genadi Velev, Darmstadt (DE); Ishan Vaishnavi, München (DE); Dimitrios Karampatsis, Ruislip (GB)

(21) Appl. No.: 18/261,821

(22) PCT Filed: Jan. 17, 2022
(86) PCT No.: PCT/IB2022/050362

§ 371 Date: Jul. 17, 2023

Related U.S. Application Data
(60) Provisional application No. 63/138,324, filed on Jan. 15, 2021.

(51) Int. Cl. H04W 48/18; H04W 48/16

(52) U.S. Cl. CPC H04W 48/18; H04W 48/16

(57) ABSTRACT

Apparatuses, methods, and systems are disclosed for network slice attribute management. One method (800) includes receiving (805) a configuration comprising a quota for a network slice parameter for access control and receiving (810) a report for the network slice parameter from a network function. The method (800) includes determining (815) to update the status of the network slice parameter based on the report for the network slice parameter and sending (820) a response to the network function.

### CROSS-REFERENCE TO RELATED APPLICATIONS

This application claims priority to U.S. Provisional Patent Application No. 63/127,988 entitled “NETWORK SLICE ATTRIBUTE MANAGEMENT” and filed on Dec. 18, 2020 for Genadi Velev, Ishan Vaishnavi, and Dimitrios Karampatsis, which application is incorporated herein by reference.

### FIELD

The subject matter disclosed herein relates generally to wireless communications and more particularly relates to network slice attribute management.

### BACKGROUND

In certain wireless networks, network slicing may be supported. A “network slice” refers to a portion of a (e.g., fifth-generation (“5G”)) core network optimized for a certain traffic type or communication service. A network slice customer (e.g., a vertical or service provider) can negotiate or request network slice characteristics from the network operator deploying the network slice. The network slice characteristics may be identified by network slice attributes. Possible network slice attributes are described in document Groupe Speciale Mobile Association (“GSMA”) 5G Joint Activity (“5GJA”) NG.116 “Generic Network Slice Template”. The Generic Network Slice Template (“GST”) is used by the network operator to derive the network slice characteristics.

### BRIEF SUMMARY

Disclosed are procedures for network slice attribute management. Said procedures may be implemented by apparatus, systems, methods, or computer program products.

One method of a first network function (“NF”), e.g., a charging function, for network slice attribute management includes receiving a configuration comprising a quota for a network slice parameter for access control and receiving a report for the network slice parameter from a second NF. The method includes determining to update the status of the network slice parameter based on the report for the network slice parameter and sending a response to the second NF.

Another method of a first NF, e.g., a network slice access control function, for network slice attribute management includes receiving a configuration for a network slice parameter for access control and a reporting configuration comprising a reporting condition. The method includes receiving requests from one or more reporting network functions to update the status of the network slice parameter and determining a status of the network slice parameter for access control. The method includes sending a report to a second NF in response to the reporting condition being met, the report including the status of the network slice parameter, and receiving a policy for the network slice parameter for access control from the second NF.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for network slice attribute management;

FIG. 2 is a signaling flow diagram illustrating one embodiment of a procedure for network slice attribute management;

FIG. 3 is a call-flow diagram illustrating one embodiment of a procedure for slice-based charging for a network slice attribute (i.e., charging quota of slice attribute);

FIG. 4A is a call-flow diagram illustrating one embodiment of a procedure for a Charging Function (“CHF”) requesting to collect information from a Network Slice Access Control Function (“NSACF”);

FIG. 4B is a continuation of FIG. 4A;

FIG. 5 is a call-flow diagram illustrating one embodiment of a procedure for a NSACF requesting Charging Data Record (“CDR”) to the CHF;

FIG. 6 is a block diagram illustrating one embodiment of a user equipment apparatus that may be used for network slice attribute management;

FIG. 7 is a block diagram illustrating one embodiment of a network apparatus that may be used for network slice attribute management;

FIG. 8 is a flowchart diagram illustrating one embodiment of a first method for network slice attribute management; and

FIG. 9 is a flowchart diagram illustrating one embodiment of a second method for network slice attribute management.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

Generally, the present disclosure describes systems, methods, and apparatus for network slice attribute management, for example managing a number of user (e.g., UEs) using the network slice and/or managing a number of data connections (e.g., PDU sessions) using the network slice. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A network slice customer (e.g., a vertical or service provider) can negotiate or request network slice characteristics from the network operator deploying the network slice. The network slice characteristics may be identified by network slice attributes. The network operator uses a Generic Network Slice Template (“GST”) to derive the network slice characteristics.

One attribute in the GST is the “number of terminals,” an attribute that describes the maximum number of terminals that can use the network slice simultaneously. This is an important input to scale the network slice and provides enough resources to the network slice. It is assumed that the GST “number of UEs per Network Slice” maps to the number of UEs registered to a S-NSSAI, i.e., the “Network Slice” from the GST template maps to S-NSSAI used in the Third Generation Partnership Project (“3GPP”) specifications. Table 1 is one example of a definition for the “Number of terminals” attribute.

TABLE 1
Number of Terminals Table
Parameters

| | |
|---|---|
| Value | Integer |
| Measurement unit | N/A |
| Example | 100 000 terminals |
| | 10 000 000 terminals (sensors) |

Attribute Presence

| | |
|---|---|
| Mandatory | |
| Conditional | X |
| Optional | |

Another attribute in the GST is the “number of connections,” an attribute that describes the maximum number of concurrent sessions supported by the network slice. This too is an important input to scale the network slice and provides enough resources to the network slice. It is a significant difference if the network slice is used to serve 10 users or 1,000,000 users simultaneously. It is assumed that the number of “connections” from the GST template can be mapped to Protocol Data Unit (“PDU”) Sessions as known from the 3GPP specifications. Table 2 is one example of a definition for the “Number of connections” attribute.

TABLE 2
Number of Connections Table
Parameters

| | |
|---|---|
| Value | N/A |
| Measurement unit | 100 000 sessions |
| | 10 000 000 sessions |
| Example | Scalability attribute |

Attribute Presence

| | |
|---|---|
| Mandatory | |
| Conditional | X |
| Optional | |

Another network slice attributed specified by GSMA are “Maximum downlink throughput” and “Maximum uplink throughput.” The Maximum downlink throughput attribute defines the maximum data rate supported by the network slice in downlink. These parameters can be used to offer different network slice contract qualities level, e.g., Gold, silver and bronze which have different maximum throughput values applied to both Guaranteed Bit Rate (“GBR”) and non-GBR traffic. Table 3 is one example of a definition for the “Maximum downlink throughput” attribute.

TABLE 3
Maximum downlink throughput Table
Parameters

| Value | Integer | |
|---|---|---|
| Measurement unit | kbps | |
| Example | 100 | Mbps |
| | 20 | Gbps |

| | |
|---|---|
| Tags | Scalability attributes |
| | KP |

Attribute Presence

| | |
|---|---|
| Mandatory | |
| Conditional | X |
| Optional | |

The Maximum uplink throughput attribute defines the maximum data rate supported by the network slice in uplink. These parameters can be used to offer different network slice contract qualities level, e.g., Gold, silver and bronze which have different maximum throughput values applied to both GBR and non-GBR traffic. Table 4 is one example of a definition for the “Maximum uplink throughput” attribute.

TABLE 4
Maximum uplink throughput
Parameters

| Value | Integer | |
|---|---|---|
| Measurement unit | kbps | |
| Example | 100 | Mbps |
| | 20 | Gbps |

| | |
|---|---|
| Tags | Scalability attributes |
| | KP |

Attribute Presence

| | |
|---|---|
| Mandatory | |
| Conditional | X |
| Optional | |

Some of these GST parameters are supported by Network Slicing management specified under 3GPP service-based management Technical Specifications (“TSs”) series (TS 28.533, TS 28.532, and TS 28.541), and by Network Slice management charging specified in TS 28.202.

With regard to the charging aspect of network slicing, it has been further investigated that Network Slice usage reporting is focused on aggregated PDU sessions usage (volume and duration) across the network slice: the Technical Report (“TR”) 32.845 concluded to use existing solution based on S-NSSAI reported as part of SMF charging. In order to enable various and enriched business models between stakeholders, charging solutions for Network Slicing need to be further investigated, beyond the basic charging capabilities framework introduced in 3GPP Release 16 (“Rel-16”). Especially when the network operator offers business-to-business (“B2B”) services or network slice as a service (“NSaaS”) to its customers, it is beneficial if the charging is collected on network slice level. The charging may be performed based on the status of the GST parameters mentioned above, e.g., “Number of terminals,” “Number of connections” or “Maximum downlink throughput” and “Maximum uplink throughput.”

It has been discussed that a new network function (“NF”) may be introduced to achieve the management of the network slice attribute(s) in a control plane of the network (e.g., 5GC). Such a new NF can be called quota management network function (“QMF”), also referred to as Network Slice Access Control Function (“NSACF”), or Network Slice Quota Access Control (“NSQAC”) and may be responsible for at least one of the following functionalities:
The QMF is aware that one or more network slice attributes to be monitored and possible quotas which need to be enforced.
The QMF collects information from other NFs about the network slice attributes to be monitored.

The charging aspects of network slice usage have been investigated in TR 32.845, but converged charging solutions for Network Slice relying on parameters in GST need to be explored. Also, a network operator may apply usage limit control for a network slice, which may imply that the access to the resources of the network slice is controlled (i.e., network slice access control) and after a certain quota is reached, new UEs to use the network slice would be rejected.

Disclosed herein are solutions that improve the charging system (e.g., charging function, “CHF”) to allow collection of charging data records (“CDRs”) for a network slice attribute in efficient way.

Disclosed herein are network functions (“NFs”) which are responsible for at least: a) being aware that one or more network slice attributes to be monitored and possible quotas which need to be enforced; b) collecting information about the network slice attributes to be monitored; and considering roaming aspects when managing the network slice attribute(s).

The quota of maximum number of UEs or number of PDU Sessions using the network slice can be maintained in the business support systems (“BSS”) in the network operator. The BSS system usually contains the data of the service-level agreements with the network operator's customers. The quota of maximum number of UEs or number of PDU Sessions can be also maintained in the operations support systems (“OSS”). Both BSS and OSS can dispose these parameters to the operations, administration, and management (“OAM”), which can configure the corresponding network functions (“NFs”) part of the network slice.

To support network slice attribute management, the below solutions describe how a quota management network functionality (“QMF”) collects information about the current global number of monitored/controlled attribute(s). The “global” means considering the attribute use by all UEs registered with the network slice whereas the UEs can be registered in the home Public Land Mobile Network (“H-PLMN”) and/or in any visited Public Land Mobile Network (“V-PLMN”) (i.e., roaming case) where the network slice services are offered. Additionally, the below solutions describe how the QMF enforces policies (i.e., actions) when the current global number of controlled attribute(s) reaches the maximum allowed number (i.e., quota or threshold).

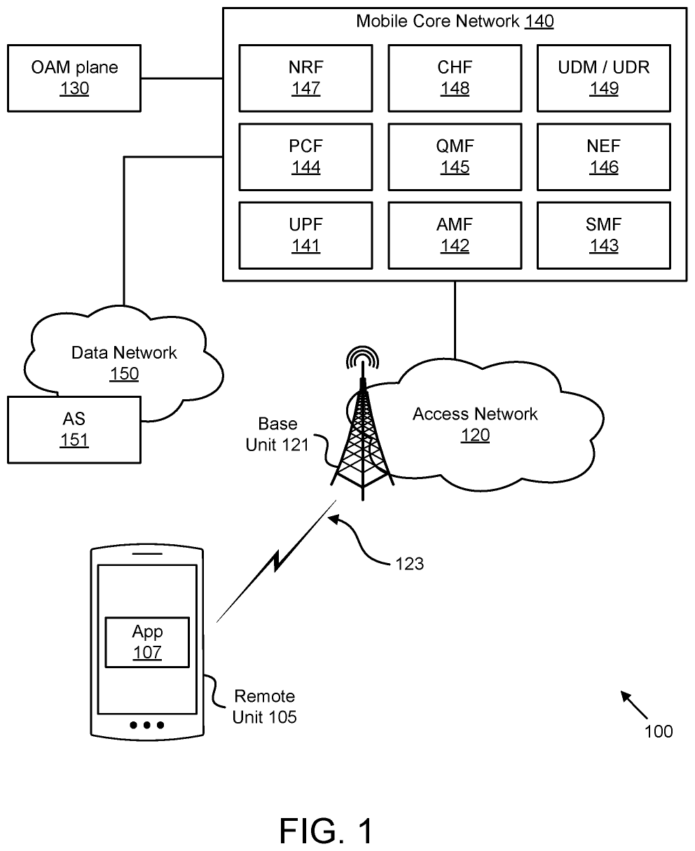

FIG. 1 depicts a wireless communication system 100 for network slice attribute management, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TB”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more downlink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 142 that serves the RAN 120, a Session Management Function (“SMF”) 143, a Policy Control Function (“PCF”) 144, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 142 is responsible for termination of Non-Access Spectrum (“NAS”) signaling, NAS ciphering & integrity protection, registration management, connection management, mobility management, access authentication and authorization, security context management. The SMF 143 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 144 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 includes a Network Exposure Function (“NEF”) 146 which is responsible for making network data and resources easily accessible to customers and network partners and a Network Repository Function (“NRF”) 147 which provides Network Function (“NF”) service registration and discovery, enabling NFs to identify appropriate services in one another and communicate with each other over Application Programming Interfaces (“APIs”). In some embodiments, the mobile core network 140 may also include an Authentication Server Function (“AUSF”), or other NFs defined for the 5GC. When present, the AUSF may act as an authentication server and/or authentication proxy, thereby allowing the AMF 142 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 143 and UPF 141. In some embodiments, the different network slices may share some common network functions, such as the AMF 142. The different network slices are not shown in FIG. 1 for ease of illustration, but their support is assumed.

The wireless communication system 100 includes an OAM/Management function 130. The OAM/Management function 130 may provide slice parameters (e.g., GSTs) to a QMF in the mobile core network 140. In various embodiments, the OAM/Management function 130 performs slice instantiation, e.g., in response to a request from a service provider.

The mobile core network 140 also includes at least one Quota Management network Function (“QMF”) 145 and a Charging Function (“CHF”) 148. The QMF 145 may be configured for monitoring (i.e., keeping count) of one or more network slice attributes per network slice, e.g., number of remote units 105 (e.g., UEs) or number of PDU Sessions using the network slice. This configuration can be: maintained in the UDM/UDR 149 (and it may be configured by the network operator, e.g., using the OAM 130); maintained the QMF 145 (this also may be configured via OAM 130); and/or may be requested by an AS 151 via NEF 146. The QMF 145 may be a stand-alone NF or may be co-located with another NF. The QMF 145 may also be referred to as a network slice access (or admission) control function or “NSACF”.

The network function in the 5GS which gathers the charging information is referred to as the Charging Function (“CHF”) 148. In various embodiments, the CHF 148 is made aware about the quotas of network slice attributes (e.g., number of UEs or PDU sessions) for which different charging tariffs are applied. The CHF 148 is able to be configured with various quotas of network slice attributes for a particular network slice, designated “S-NSSAIx.” The CHF 148 is able to request data analytics regarding the quotas for network slice attributes of S-NSSAIx. The CHF 148 can enforce different charging policies depending on the exceeding of the various quotas for network slice attributes of S-NSSAIx.

In certain embodiments, the SMF 143 may create or update the charging record in the CHF 148 during the PDU Session establishment procedure. For example, the CHF 148 checks whether a particular network slice (S-NSSAI) is subject to quota management based on the number of PDU sessions, if so, whether the Slice Service-Level Agreement (“SLA”) (i.e., the maximum number of PDU sessions) is not exceeded with the establishment of the new PDU session. If it is not exceeded, the PDU session is accepted and the count for “Nb of PDU sessions” is increased by one. Otherwise, if the number of PDU Sessions is exceeded, then the PDU Session is rejected. In some embodiments, the SMF 143 may update the CHF 148 during the PDU session release procedure.

While FIG. 1 depicts components of a 5G RAN and a 5G core network, the described embodiments for network slice attribute management apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 142 may be mapped to an MME, the SMF 143 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the term “NSACF” is used for the network function that monitors of network slice attributes per network slice, but it is replaceable by any other suitable management function, such as QMF, vNSACF, etc. The below operations are described mainly in the context of 5G NR. However, the below described solutions/methods are also equally applicable to other mobile communication systems for network slice attribute management.

In some embodiments, a PLMN may have a global admission control function that manages a network slice attribute (also referred to as network slice parameter) for a network slice on a global level among various administrative domains of the PLMN and/or various V-PLMNs supporting a particular network slice with which the H-PLMN has a roaming agreement. The global admission control function determines whether a (global) slice quota for the network slice parameter is reached and enforces policy when the slice quota is reached.

In some embodiments, one or more proxy admission control functions may be deployed in the various administrative domains and/or various V-PLMNs, where a proxy admission control function monitor the status of the network slice parameter relative to a local quota. Here, the local quota is a portion of the slice quota apportioned to the administrative domain or V-PLMN. In certain embodiments, the sum of all local quotas is equal to the slice quota.

The below described solutions describe network slice instance charging, e.g., based on the network slice attribute (i.e., used for network slice instance charging) derived from the GST parameters, such as UL/DL Throughput for a network slice, number of PDU sessions of network slice, or registered subscribers of network slice.

For efficient network slice attribute management, a dedicated network functionality manages (or monitors or keeps a count) of one or more network slice attributes per network slice, for which the monitoring/controlling of a slices attribute is required. For example, the dedicated network functionality can be called quota management network function (“QMF”) or Network Slice Access/Admission Control Function (“NSACF”). The QMF/NSACF may be stand-alone or can be co-located with another network function.

The QMF/NSACF may implement the following functionality:
Collecting information about the network slice attribute (i.e., ‘controlled slice attributes’ as explained below);
Performing network slice access control for the ‘controlled slice attribute;’
Exposing information about the ‘controlled slice attribute’ to other NFs in 5GC, to the Charging Function (“CHF”) and to the OAM.

Each network slice is identified by the S-NSSAI. The QMF/NSACF may manage one or more of the S-NSSAI attributes (called also ‘controlled slice attributes,’ slice attributes' or ‘parameters,’ and shown as “AttributeID” in the signaling exchanges) per network slice. Similarly, the CHF can perform charging for one or more network slice attributes.

The slice attributes may be:
Number of terminals, i.e., the number of UEs concurrently registering for a network slice;
Number of connections, i.e., the number of PDU Sessions concurrently established within a network slice associated with all Data Network Names (“DNNs”);
Maximum uplink throughput, i.e., maximum data rate supported by the S-NSSAI in uplink;
Maximum downlink throughput, i.e., maximum data rate supported by the S-NSSAI in downlink.
Maximum UL/DL throughput per UE, which uses the network slice.

For each of the above attributes there can be one or more quotas of maximum number or upper bound (called just “quota” or “slice quota”) in the remainder of this disclosure.

In various embodiments, the CHF collects charging information/data from the QMF/NSACF per network slice attribute. For this purpose, the CHF may subscribe with the QMF/NSACF for network slice level reporting for the status of a slice attribute (e.g., periodic current status of the attribute and/or based on event-triggered status). The CHF may subscribe with the QMF/NSACF to obtain reports when a slice attributes quota is about to be reached. There may be one or multiple such slice attributes quotas used by the CHF and configured in the QMF/NSACF; and such quotas may be called charging slice quotas. The QMF/NSACF collects the current status of the slice attribute from other NFs in the 5GC (e.g., called reporting NFs, e.g., AMF, SMF or PCF) or from the OAM.

The QMF/NSACF may maintain different types of slice quotas, e.g.,
Slice quotas for access restriction/control, which can be locally configured in the QMF/NSACF or configured and updated from the OAM, or configured and updated by the CHF.
Charging slice quotas, which can be configured by CHF.

Either the one type or both types of slice quotas may be configured in the QMF/NSACF. The slice quotas for access restriction and the charging slice quotas may have different values or same values, depending on the business case and requirements from the slice customer (or tenant). For example, a slice customer may negotiate an SLA with the network operator that a higher charging is applied when a slice attribute exceeds quota Q1, and the network access control needs to be activated when a slice attribute exceeds quota Q2. In such example, the quota Q1 would be the charging slice quota managed in the CHF and the CHF may collect the slice attribute data from the QMF/NSACF. The quota Q2 would be the slice quota for access control. The quota Q2 may be managed in the CHF and configured in the QMF/NSACF, or the quota Q2 may be managed in the QMF/NSACF and configured by the OAM.

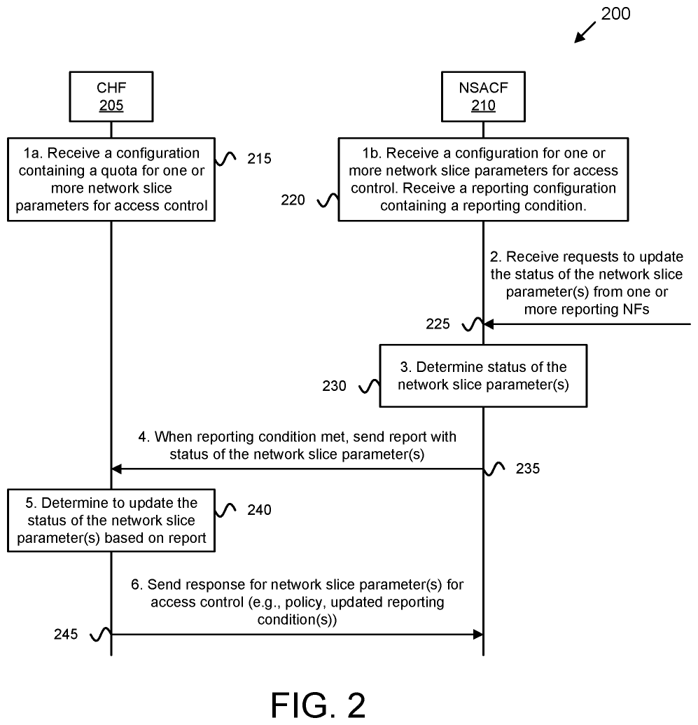

FIG. 2 depicts a high-level procedure 200 for controlling a network slice attribute, i.e., managing the quota of the network slice attribute. The procedure 200 involves a Charging Function (“CHF”) 205 and a Network Slice Access Control Function (“NSACF”) 210. The CHF 205 may be one embodiment of the CHF 148 and the NSACF 210 may be one embodiment of the QMF 145. A detailed description of the procedure 200 is as follows:

At Step 1a, the CHF 205 receives (e.g., from the operations, administration, and management (“OAM”) system) a configuration that contains a quota for at least one network slice parameter for access control (see block 215). In one embodiment, the network slice parameter includes the number of UEs currently registered with the network slice. In another embodiment, the network slice parameter includes a number of data connections currently established in the network slice. In certain embodiments, the received configuration may include a charging policy for a network slice instance.

The network slice may be identified by a S-NSSAI. The S-NSSAI uniquely identifies a network slice and is comprised of a Slice/Service type field and a Slice Differentiator field. The Slice/Service type (“SST”) refers to the expected network slice behavior in terms of features and services. The SST field is 8 bits in length and may have standardized and non-standardized values: values ‘0’ to ‘127’ belong to the standardized SST range and are defined in 3GPP TS 23.501, and values ‘128’ to ‘255’ belong to the Operator-specific range. The Slice Differentiator (“SD”) is optional information that complements the Slice/Service type(s) to differentiate between multiple network slices of the same SST value. For instance, for an SST of value eMBB, multiple SDs may be defined such as “Company X eMBB slice,” “Company Y eMBB slice” etc. The SD field is 24 bits in length.

At Step 1b, the NSACF 210 also receives (e.g., from the OAM system) a configuration to manage the one or more network slice attributes for access control (see block 220). The NSACF 210 further receives a reporting configuration that includes a reporting condition. In some embodiments, the reporting configuration indicates a quota value for the network slice parameter(s).

At Step 2, the NSACF 210 collects information about the status of the controlled slice attributes of one or multiple slices. In the depicted example, the NSACF 210 receives requests from one or more reporting network functions to update the status of the network slice parameter (see messaging 225). In one embodiment, the status of the controlled network slice parameters is collected directly from the AMFs/SMFs. In another embodiment, the status of the controlled network slice parameters is collected indirectly from a distributed NSACF (i.e., a vNSACF), where the distributed NSACF obtains the status from the AMFs/SMFs.

At Step 3, the NSACF 210 determines (e.g., updates) a status of the controlled network slice parameter(s) (see block 230).

At Step 4, upon meeting a reporting condition in the reporting configuration, the NSACF 210 sends to the CHF 205 a report containing a status of the controlled network slice parameter(s) (see messaging 235), e.g., containing a network slice identifier (i.e., S-NSSAI) of a monitored network slice instance and current status of the network slice parameter(s). In certain embodiments, the status of the network slice parameter(s) is contained within a slice-specific charging data request.

At Step 5, the CHF 205 determines to update the status of the network slice parameter(s) based on the received report for the network slice parameter(s) (see block 240). In some embodiments, the CHF 205 compares the updated status for the network slice parameter(s) to the configured quota value(s) for the monitored network slice parameter(s).

Optionally, the CHF 205 may report the quota status to the OAM system (management system) and the OAM system can create (or configure or update) the policies to be enforced when the quota status is reached. In one embodiment, the OAM may send an updated quota value.

At Step 6, the CHF 205 sends a response to the NSACF 210. In certain embodiments, the status of the network slice parameter(s) is contained within a slice-specific charging data response (see messaging 245). If a quota is reached, then the CHF 205 may create and send policy information (i.e., dynamic-policy configuration) to the NSACF 210. The policy can enforce actions in the NSACF 210 and policy-enforcing NFs, such as start rejecting new UEs or new PDU Sessions, or throttling the data rate of the UEs using the S-NSSAI. The policy may be applicable depending on various conditions, e.g., type of UEs, type of subscribers, whether the UEs has a different default subscribed S-NSSAI, etc. Alternatively, the response sent by the CHF 205 may include an updated quota value for the monitored network slice parameter.

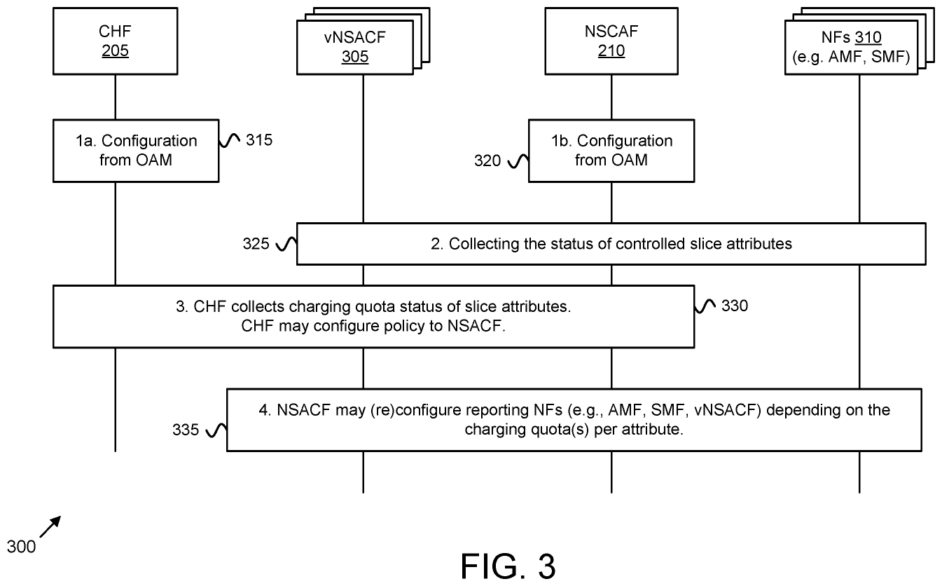

FIG. 3 represents a high-level description of the procedures for slice-based charging for slice attributes, according to embodiments of the disclosure. The procedure 300 involves the CHF 205, the NSACF 210, at least one vNSACF 305 (i.e., a distributed instance of the NSACF, which may be in the serving or visited network), and a set of reporting network functions (“NFs”) 310. A detailed description of the steps of the procedure 300 is as follows:

At Step 1a, the CHF 205 may be configured by the management system (e.g., OAM) with the charging policy for an S-NSSAI (see block 315). For example, the network slice may be charged for one or more network slice attributes when exceeding various quotas, i.e., charging slice quotas. The OAM may use the network slice attribute from the slice SLA or other contracts between the network operator and the network slice customer, e.g., based on the GST parameters.

At Step 1b, the NSACF 210 is also configured by the OAM system to to control/manage one or more network slice attributes for a network slice identified by S-NSSAI (see block 320). The quota for the network slice attribute may be called slice quotas for access restriction.

The OAM system is aware about the requirement to control a quota of a network slice attribute from the SLA or other contracts between the network operator and the network slice customer. Such quotas may be used for network slice access restriction/control. For example, a combination and particular values of the GST parameters may result in a specific Network Slice Type (“NEST”) and further used by the OAM system to create a Network Slice Template (“NST”). The OAM system may determine the configuration of the NSACF 210 based on the Network Slice Template.

At Step 2, the NSACF 210 collects information about the status of the slice attributes (see block 325). The network slice quota for access control of one or multiple slices. The status of the controlled slice attributes information is collected from the vNSACF(s) 305 and from the reporting NFs 310 (e.g., AMF, SMF, PCF, etc. in the 5GC control plane).

The NSACF 210 may determine which NFs are responsible for managing the particular controlled slice attribute. Alternatively, this information may be directly configured in the NSACF 210 by the OAM in Step 1b. For example, if the controlled slice attribute is number of UEs concurrently registering for a network slice, the NSACF 210 determines that the AMFs serving the corresponding S-NSSAI needs to be discovered. Examples of control plane NFs may be AMF, SMF, PCF, which report to the NSACF 210 and can be also an enforcement policy point when a quota has been consumed. In certain embodiments, the NSACF 210 may discover these NFs by interrogating with a NRF (e.g., the NRF 147).

The NSACF 210 may also exchange signaling with other NSACFs (e.g., in distributed QMF deployment) in one of the following cases:
when the network covers a large territory and distributed QMFs are used for scalability; or
when the network slice is used by roaming UEs (i.e., the network slice spans at least two networks, the one is the home network, and the other is the visited network).

Such distributed NSACFs may be also called “visited NSACF” (“vNSACF”), e.g., where a roaming interface between the home NSACF (e.g., NSACF 210) and the visited NSACFs (e.g., vNSACFs 305) is introduced.

At Step 3, the CHF 205 may collect charging quota status of slice attributes from the NSACF 210 (see block 330). This step is between the CHF 205 and the NSACF 210 for charging purposes of network slice attributes. The CHF 205 may be aware about the availability of the NSACF 210 based on the local configuration or based on OAM configuration. In certain to embodiments, the CHF 205 may use the NRF services to discover the NSACF 210 for the S-NSSAI.

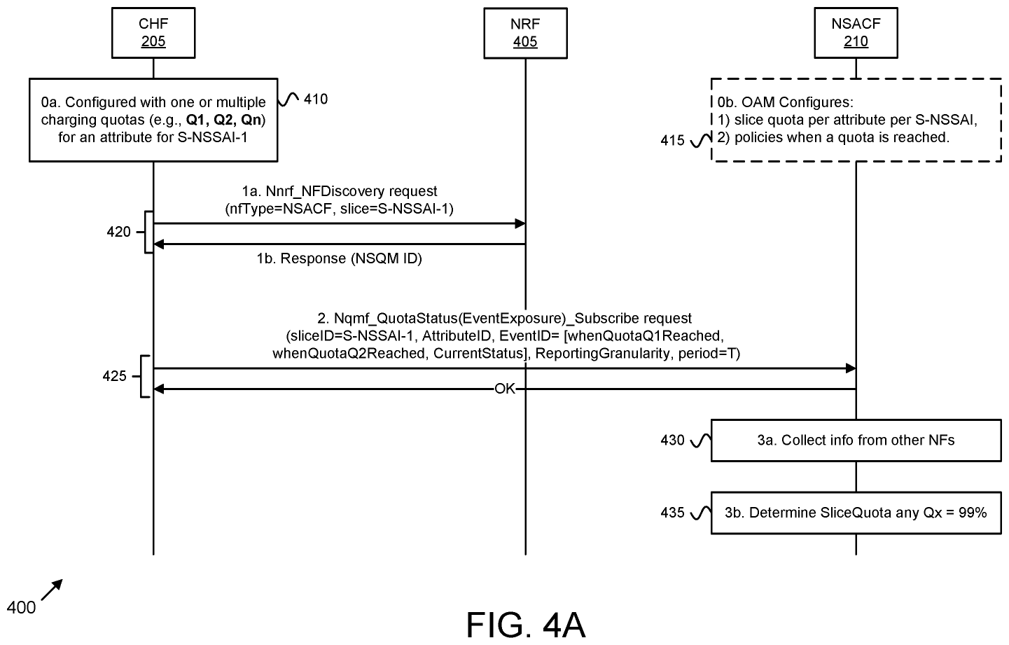

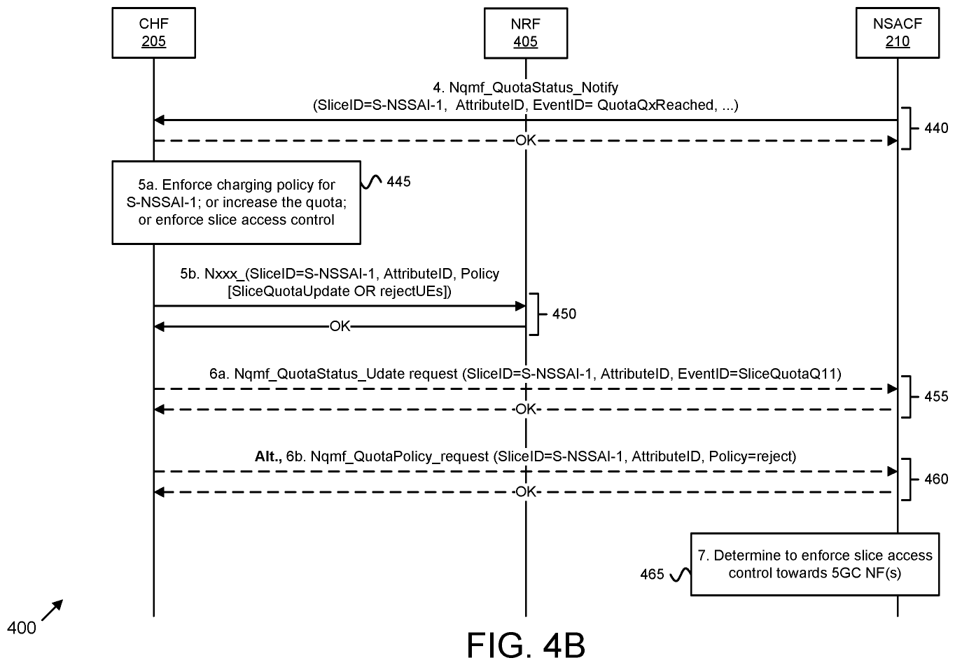

There may be at least two possible way to initiate the charging data collection in the CHF 205. As a first option, the CHF 205 subscribes with the NSACF 210 to be notified about the status of the charged slice attribute. In other words, the CHF 205 may configure the NSACF 210 to report the status of the (charged) slice attribute and the charging slice quota(s). The NSACF 210 may report the status of slice attributes with respect to charging quota(s) which may be configured in the NSACF 210 by the CHF 205. This option is described in further detail below with reference to FIGS. 4A-4B.

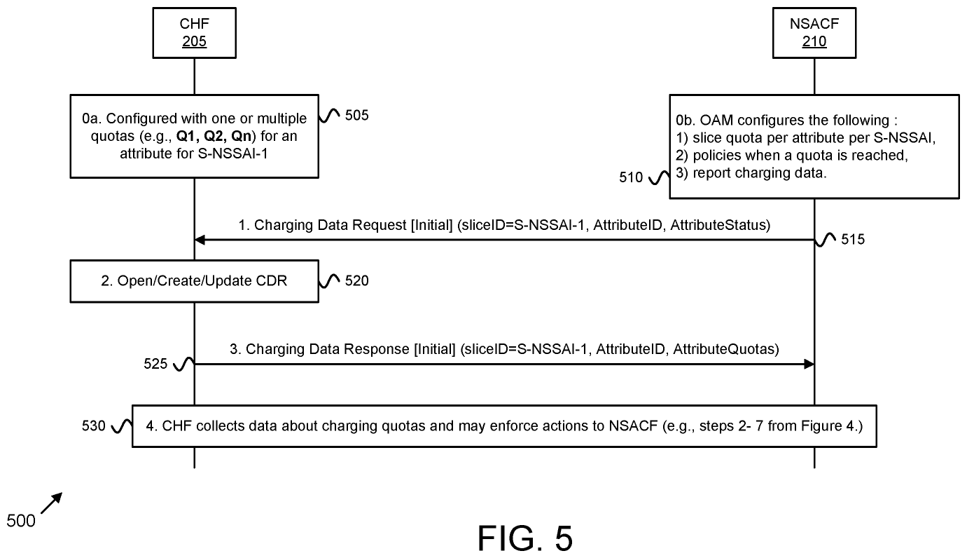

As a second option, the NSACF 210 may initiate charging reports based on configuration (e.g., from OAM). The NSACF 210 may create (or configure or update) the charging records (e.g., CDRs) in the CHF 205. This option is described in further detail below with reference to FIG. 5.

In addition, the CHF 205 may configure a policy in the NSACF 210 to be enforced when a network slice attribute quota is reached. In other words, the CHF 205 may configure network slice quotas for access restriction/control.

At Step 4, based on the network slice quota status of a slice attribute in the NSACF 210 (e.g., a quota is about to be reached or exceeded), the NSACF 210 may (re)configure the reporting NFs (see block 335). For example, the NSACF 210 may create or update the local reporting quotas in the reporting NFs, and thus to receive report information with finer granularity. Alternatively, the NSACF 210 may enforce a network slice access control meaning that a network slice attribute may be restricted, i.e., the new UE registrations or new PDU Session establishments may be rejected.

The benefit of the method proposed in FIG. 3 is that the signaling on network slice level, i.e., not on per UE level. Using network slice level signaling it is expected that the signaling minimized compared on the per UE level signaling. Further, the central status and quota of controlled slice attribute is managed centrally in the NSACF 210, which allows the NSACF 210 to enforce policy (e.g., configure policy) in other NFs to enforce particular action (e.g., start/end rejecting new UEs or new PDU Sessions).

Note that if the OAM configures the CHF 205 (e.g., as in FIG. 4A) and/or the NSACF 210 (e.g., as in FIG. 5) to perform charging for the network slice attributes, then the OAM does not configure the AMF or SMF to perform charging record creation (or update). In other words, the OAM determines to configure the 5GC NFs how the network slice charging for a slice attribute is performed.

FIGS. 4A-4B depict a detailed procedure 400 of step 3 from FIG. 3, according to embodiments of the disclosure. The procedure 400 details how a CHF is configured to collect information about the current status of controlled slice attribute(s) from the one or more NSACFs. The procedure 400 involves the CHF 205, the NSACF 210, and a NRF 405 (e.g., one embodiment of the NRF 147). A detailed description of the steps of the procedure 400 is as follows:

Beginning on FIG. 4A, at Step 4a the CHF 205 is configured with one or multiple quotas (e.g., Q1, Q2, . . . , Qn) for an attribute of a network slice identified by S-NSSAI-1 (see block 410). Such quotas can be for charging purposes (in such case called “charging quotas”) but may be also for other purposes as shown in Step 6.

At Step 0b, optionally (if Step 6 is not performed), the NSACF 210 may be configured (e.g., by the OAM system) with information similar to step 1 from FIG. 3 (see block 415). However, this configuration is required as alternative to Step 6b. When Step 0b id performed, the NSACF 210 may be configured with 1) a slice quota per attribute per S-NSSAI, and 2) policies for when a quota is reached.

At Step 1, the CHF 205 may perform NF discovery procedure in order to discover the NSACF 210 which is responsible to manage the controlled slice attributes for S-NSSAI-1 (see messaging 420). For example, the CHF 205 may send to the NRF 405 the Nnrf_NFDiscovery request, where the NF type is set to NSACF (i.e., nfType=NSACF, alt. nfType=QMF) and the slice ID (i.e., S-NSSAI) of the desired network slice instance is also included (i.e., slice=S-NSSAI-1).

The NRF 405 replies with the ID (e.g., Fully Qualified Domain Name (“FQDN”) or IP address) of the network function for slice quota management (e.g., NSACF) which has registered itself before.

At Step 2, the CHF 205 requests to subscribe to the NSACF 210 for notification about: a) either the current status of the controlled slice attribute or b) whether a quota for a controlled slice attribute is reached (or within a predetermined range of the quota) (see messaging 425). The CHF 205 may use EventExposure service offered by the NSACF 210 where a new Event type is specified. The CHF 205 may alternatively use a threshold monitoring service, e.g., as described in 3GPP TS 28.532. In this case, the OAM would configure the thresholds. In yet another alternatively, a new service (e.g., Nnsacf_QuotaStatus or Nqmf_QuotaStatus) can be offered by the NSACF 210.

For example, the CHF 205 may send Nqmf_QuotaStatus_Subscribe request or Nqmf_EventExposure_Subscribe request containing the list of parameters (SliceID=S-NSSAI-1, AttributeID, EventID=[whenQuotaQ1Reached, whenQuotaQ2Reached, CurrentStatus], ReportingGranularity, Period=T). Alternatively, the CHF 205 may send Nnsacf_QuotaStatus_Subscribe request or Nnsacf_EventExposure_Subscribe request containing the aforementioned list of parameters. The SliceID parameter identifies the specific network slice for which the request from CHF 205 is initiated. The AttributeID parameter identifies the controlled slice attribute, e.g., the number of UEs registered with the network slice, the number of PDU Sessions established with the network slice, or throughput in the network slice.

The EventID parameter identifies the reporting (or notification) event upon which the NSACF 210 may send a status report/notification to the CHF 205 when a specific quota is reached. For example, “whenQuotaQ1Reached” identifies that the charging quota Q1 is reached. Note that one charging quota may be a kind of “global quota” of the attribute, which means the sum of the global status of the slice attribute in the home network and in all visited networks (i.e., for roaming UEs). It is also possible, that a charging quota may be a “local quota” for the slice attribute, e.g., applicable in the home network only, or in visited networks only.

Examples for Quota ‘Q1’ may be a numerical value (e.g., 1000) which is relevant to the Attribute ID. For example, if the Attribute ID is ‘number of registered UEs,’ then Q1 would mean 1000 UEs registered with the S-NSSAI. If the Attribute ID is ‘number of established PDU Sessions,’ then Q1 would mean 1000 PDU Sessions established in the S-NSSAI. If the Attribute ID is UL/DL throughput then Q1 would mean 1000 Mbps throughput in the S-NSSAI.

The CHF 205 may configure multiple quotas as described above. In addition, the EventID may identify the current status of the slice attribute, e.g., “CurrentStatus.” The CHF 205 may also use the “ReportingGranularity” parameter to identify a charging event reporting when the EventID is the current status of the slice attribute (e.g., CurrentStatus). In certain embodiments, the granularity may be a change of current status of the attribute.

For example, if the “ReportingGranularity” is set to ‘2’, this means that if the current status number in the reporting NF changes by 2 (e.g., two UEs which leave or perform new registration or deregistration in the AMF), the event-based reporting/notification is triggered. In case of UL/DL throughput attribute, the “ReportingGranularity” can be expressed in increase or decrease by, e.g., 2 Mbps. In other words, event-based reporting/notification is triggered when the current status of the attribute increases or decreases by the factor indicated by the “ReportingGranularity” parameter.

When the “ReportingGranularity” is sent to “1”, the reporting NF should send a notification to the NSACF 210 for new registered UEs, or new established PDU Sessions or new increased UL/DL throughput. The term “new” is meant for UEs which perform Registration procedure and include the S-NSSAI-1 as a new requested S-NSSAI, or establish a “new” PDU Session to the S-NSSAI-1. If a UE moves from one AMF to another (e.g., inter-AMF mobility), the AMF may not immediately send notification to the NSACF 210, as the status of the attribute would be reduced in one NF (e.g., source AMF) and increased in another NF (e.g., target AMF).

The CHF 205 may also use the “Period” parameter to identify the periodicity of reporting from the NSACF 210 to the CHF 205, e.g., every 5 minutes.

At Step 3a, the NSACF 210 collects information about the controlled slice attributes from other NFs (e.g., called reporting NFs) in the 5GC or from the OAM (using the performance assurance services) (see block 430). For example, this can be performed by the NSACF 210 by subscribing for events exposure with the reporting NFs and receiving the reports periodically on event-based manner.

At Step 3b, the NSACF 210 may determine that a quota requested from the CHF 205 in Step 2 is about to be reached (see block 435). For example, the NSACF 210 may determine to trigger the reporting when the quota is about 99% (or any other suitable threshold configured by the OAM or a Network Data Analytics Function (“NWDAF”) or CHF 205) when the corresponding quota (e.g., Q1, Q2, . . . , Qn) is consumed.

Continuing on FIG. 4B, at Step 4 the NSACF 210 sends a Notification message to the CHF 205 when the event provided (or configured or subscribed to) in Step 2 occurs (see messaging 440). For example, the NSACF 210 may send Nqmf_QuotaStatus/EventExposure_Notify (SliceID=S-NSSAI-1, AttributeID, EventID=QuotaQxReached, . . . ) where the “EventID=QuotaQxReached” corresponds to an event subscribed by the CHF 205 in Step 2, the placeholder “Qx” being replaced with the consumed quota(s) (e.g., Q1, Q2, Qn). The CHF 205 may send an acknowledgement about the received notification. Alternatively, the NSACF 210 may send Nnsacf_QuotaStatus/EventExposure_Notify messages with the aforementioned parameters.

At Step 5, the CHF 205 records the reported data from the NSACF 210 (e.g., in updated CDR) and the CHF 205 determines whether a network slice quota has been reached. The CHF 205 may enforce charging policy for S-NSSAI; or the CHF 205 may increase the charging slice quota; or the CHF 205 may enforce network slice access control towards the NSACF 210.

At Step 5a, the CHF 205 applies the charging for the network slice instance according to the charging policy and the quotas for S-NSSAI-1 which has been configured in Step 0a (see block 445).

Alternatively, particularly if a maximum quota has been reached, e.g., based on the configuration from the OAM system, the CHF 205 may notify the OAM of a possible slice overuse (or capacity consumption). The OAM may then for example increase the charging quota, or notify the network slice instance customer or reject any further use of the network slice.

At Step 5b, the CHF 205 may notify the OAM system about the current condition in the network slice (e.g., S-NSSAI) (see messaging 450). Alternatively, the CHF 205 may request a policy to be enforced due to the consumed quota Qx. One example is that the Quota value is increased by the OAM system. Another example is that the OAM system request the CHF 205 to create a policy to start limitation (i.e., rejection) of the use of the resources on the S-NSSAI-1, which would result in performing of Step 6b.

For example, the Management services operation can be used, e.g., Nxxx_(SliceID=S-NSSAI-1, AttributeID, Policy [SliceQuotaUpdate OR rejectUEs]), where the OAM may configure a policy to be enforced in the CHF 205. The policy rule may be to enforce slice access control, i.e., to start limitation (i.e., reject) further use of the network slice resources. For example, the CHF 205 can use getMOIAttributes operation (i.e., get one or more Managed Object instances) towards the OAM system.

At Steps 6, the CHF 205 may determine to send a configuration (or request) to update the quota in the NSACF 210. Alternatively, the CHF 205 may request the NSACF 210 to start network slice access control when the slice quota is exceeded. This step may depend on the outcome of Step 5.

In Step 6a, if the quota value is to be updated, the CHF 205 may send to NSACF 210 an update request, e.g., Nqmf_QuotaStatus_Update request (or Nqmf_EventExposure_Update request) including a new quota value for Qx (see messaging 455). The NSACF 210 applies the new quota value. Alternatively, the CHF 205 may send Nnsacf_QuotaStatus_Update/EventExposure_Update messages that include the new quota value.

Step 6b shows an alternative to Step 0b where the CHF 205 may configure (or request) the NSACF 210 to apply network slice access control. In other words, the CHF 205 may send a new policy is to be applied. The CHF 205 may request to start limitation (i.e., rejection) of the use of the resources on the S-NSSAI-1 (see messaging 460). In such case the CHF 205 may send to the NSACF 210, for example, Nqmf_QuotaPolicy_request (SliceID=S-NSSAI-1, AttributeID, Policy=reject). The policy has the meaning that a slice access control is to be applied, which means that the NSACF 210 may enforce start of rejection for new UEs to register or new PDU Sessions to be established. Alternatively, the NSACF 210 may send an Nnsacf_QuotaPolicy_request message with the aforementioned parameters/policy.

At Step 7, the NSACF 210 may enforce the network slice access control towards other NFs in the 5GC (e.g., policy enforcement NF like AMF, or SMF, etc.) (see block 465). For example, the NSACF 210 may instruct (or send a request) to the NFs responsible for the network slice access control to start rejecting further increase of the network slice attribute, e.g., start rejecting new UE registrations or new PDU Session establishments.

The benefit of the method described in FIGS. 4A-4B is that the CHF 205 does not collect information per UE, but instead the CHF 205 gathers status reports on per a network slice, e.g., from the NSACF 210. Such per network slice signaling between NSACF 210 and CHF 205 omits the need of signaling between AMF/SMF and the CHF 205, which is per UE-based signaling. In addition, the CHF 205 may instruct the NSACF 210 to start or stop the access control for a network slice.

FIG. 5 depicts an alternative procedure 500 for CHF requesting to collect information, according to embodiments of the disclosure. The procedure 500 involves the CHF 205 and the NSACF 210. The procedure 500 describes a detailed procedure of step 3 from FIG. 3, where the NSACF 210 is configured to initiate signaling to create (and update) charging record (e.g., CDR) in the CHF 205 for the particular network slice and represents an alternative to the procedure 400. Similar to FIGS. 4A-4B, the CHF 205 can collect information from the NSACF 210 about the current status of controlled slice attribute. A detailed description of the procedure 500 is as follows:

At Step 0a, the CHF 205 is configured with one or multiple quotas (e.g., Q1, Q2, . . . , Qn) for an attribute of a network slice identified by S-NSSAI-1 (see block 505). This is similar to Step 0a in FIG. 4A, with the difference that the CHF 205 does not firstly initiate communication towards the NSACF 210, i.e., the CHF 205 does not discover NSACF 210, but waits until the NSACF 210 sends a request to the CHF 205.

At Step 0b, the NSACF 210 may be configured (e.g., by the OAM system) with information similar to step 1 from FIG. 3 (see block 510). This is similar as Step 0b from FIG. 4A, with the additional configuration that the NSACF 210 should initiate charging data request towards the CHF 205. In some embodiments, the NSACF 210 may be configured with 1) a slice quota per attribute per S-NSSAI, 2) policies for when a quota is reached, and 3) a reporting configuration for charging data.

Please note that the slice quotas (e.g., Quota-X and Quota-Y) are slice quotas for access restriction/control which trigger an access control (e.g., rejection of new UE registrations or new PDU Session establishments) towards the policy-enforcing NFs (e.g., AMF, SMF or PCF). The quotas Q1, Q2, Qn, etc., configured in the CHF 205 are charging quotas configured in the CHF 205. Therefore, the quotas Q1, Q2, Qn may be different from the quotas X, Y. The OAM may also configure the reporting conditions from NSACF 210 to the CHF 205.

At Step 1, the NSACF 210 sends a request to the CHF 205 to create a charging data record (“CDR”) for a specific network slice attribute (see messaging 515). The request may include a network slice ID (e.g., S-NSSAI) and network slice attribute identifier (e.g., AttributeID). The AttributeID may be mandatory if multiple controlled slice attributes have been configured for the network slice. For example, the NSACF 210 may send the CHF 205 a Charging Data Request [Initial] (SliceID=S-NSSAI-1, AttributeID, AttributeStatus). The AttributeID parameter identifies the network slice attribute (e.g., number of UEs concurrently registered, or number of number of PDU Sessions in the S-NSSAI-1). The AttributeStatus parameter may indicate the current status of the attribute (e.g., the current number of UEs or PDU Sessions using the S-NSSAI-1).

At Step 2, the CHF 205 creates a charging record for the network slice and for the specific controlled (or charged) slice attribute (see block 520).

At Step 3, the CHF 205 responds with Charging Data Response [Initial] (SliceID=S-NSSAI-1, AttributeID, AttributeQuotas) (see messaging 525). The AttributeQuotas parameter indicates a response the NSACF 210 is to take. In one embodiment, the AttributeQuotas parameter indicates a new quota value for the reached network slice parameter. In another embodiment, the AttributeQuotas parameter indicates a policy to be applied while the quota is consumed, i.e., indicating that a slice access control is to be applied, which means that the NSACF 210 may enforce start of rejection for new UEs to register or new PDU Sessions to be established.

Optionally, the CHF 205 may also subscribe with the NSACF 210 to collect charging data. In other words, Step 3 of FIG. 5 may be combined with the subscription of Step 2 from FIG. 4A.

At Step 4, the CHF 205 collects status data to monitor the charging quota(s) (see block 535). For example, the Steps 2 to 7 from FIGS. 4A-4B can be performed. The CHF 205 collects the status of the controlled slice attribute from the NSACF 210. The CHF 205 updates the CDRs and may enforce network slice access control towards the NSACF 210.

The benefit of the method described in FIG. 5 is that the NSACF 210 initiates signaling to create and update the charging record in the CHF 205 on per network slice bases, which results in much less signaling compared to the known prior-arts where the AMF or SMF create and update the charging CDRs in the CHF 205 on per UE basis.

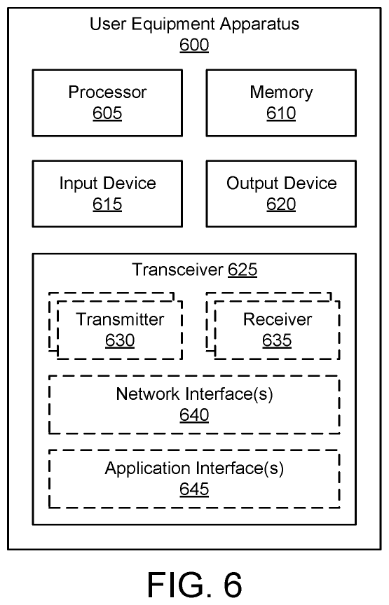

FIG. 6 depicts a user equipment apparatus 600 that may be used for network slice attribute management, according to embodiments of the disclosure. In various embodiments, the user equipment apparatus 600 is used to implement one or more of the solutions described above. The user equipment apparatus 600 may be one embodiment of the remote unit 105, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to network slice attribute management and/or mobile operation. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

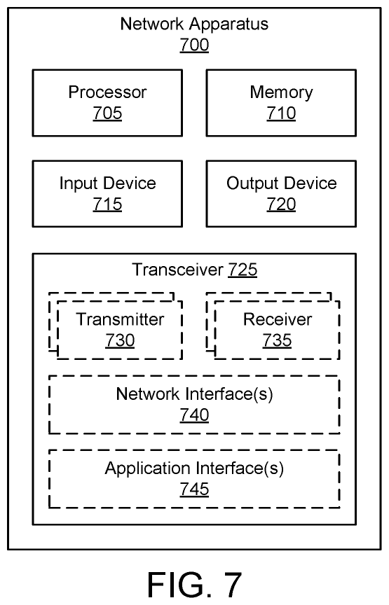

FIG. 7 depicts a network apparatus 700 that may be used for network slice attribute management, according to embodiments of the disclosure. In one embodiment, network apparatus 700 may be one implementation of a global network slice admission control function, such as the QMF 145 and/or the NSACF 210, as described above. In another embodiment, the network apparatus 700 may be one implementation of a charging function, such as a CHF 148 and/or the CHF 205, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 controls the apparatus 700 to perform the CHF behaviors described above. In some embodiments, the transceiver 725 receives (i.e., via a network interface 740) a configuration comprising a quota for a network slice parameter (i.e., at least one network slice parameter) for access control. Additionally, the transceiver 725 also receives a report (i.e., periodic status report or event-based notification) for the network slice parameter from a second NF (e.g., QMF/NSACF). The processor 705 determines to update the status of the network slice parameter based on the report for the network slice parameter and sends a response to the second NF via the transceiver 725.

In some embodiments, the network slice parameter is a number of UEs currently registered with the network slice, a number of data connections (e.g., PDU Sessions or PDN Connections) currently established in the network slice, or combinations thereof. In some embodiments, the received report for the network slice parameter includes a network slice identifier and current status of the network slice parameter.

In some embodiments, the first network function is a charging function. In such embodiments, the transceiver 725 receives the report for the network slice parameter by receiving a slice-specific charging data request and sends the response to the second NF by sending a charging data response which contains a policy for the network slice parameter.

In certain embodiments, the policy for the network slice parameter is determined based on the report from the second NF and the quota for the network slice parameter for access control. In certain embodiments, the received configuration contains a charging policy for a network slice instance. In such embodiments, the processor 705 may generate a charging record (i.e., CDR) for the network slice parameter based on the received charging data request and the charging policy.

In some embodiments, the second network function includes a NSACF and the processor 705 determines that the quota is reached based on the received report. In such embodiments, the policy for the network slice parameter sent to the NSACF contains A) an updated quota value of the network slice parameter/attribute, or B) a policy to start/stop enforcing access control (e.g., rejecting new UEs or PDU Sessions). In certain embodiments, the processor 705 notifies an OAM system in response to determining that the quota is reached and receives, from the OAM system, the updated quota value and/or the policy to start/stop enforcing access control.

In some embodiments, the policy for the network slice parameter includes a configuration for reporting a status of the network slice parameter, the configuration indicating the network slice parameter for admission control and a reporting granularity for reporting the status of the network slice parameter.

In various embodiments, the processor 705 controls the apparatus 700 to perform the NSACF and QMF behaviors described above. In some embodiments, the transceiver 725 receives (i.e., via a network interface 740) and a configuration for a network slice parameter for access control (e.g., a general configuration to collect information from AMFs/SMFs and monitor the status for at least one network slice parameter). The transceiver 725 may also receive a reporting configuration containing a reporting condition. Via the transceiver 725, the processor 705 receives requests from one or more reporting network functions (e.g., AMFs or SMFs) to update the status of the network slice parameter and the processor determines a status of the network slice parameter for access control. Via the transceiver 725, the processor 705 sends a report (e.g., a periodic report or an event-based notification) to a second NF (e.g., CHF) in response to the reporting condition being met, the report including the status of the network slice parameter, and receives a policy for the network slice parameter for access control from the second NF.

In some embodiments, the second network function is a charging function. In such embodiments, reporting the status of the network slice parameter includes transmitting a slice-specific charging data request. In such embodiments, receiving the policy from the second NF includes receiving a charging data response. In some embodiments, the network slice parameter includes a number of UEs currently registered with the network slice, or a number of data connections (e.g., PDU Sessions or PDN Connections) currently established in the network slice.

In some embodiments, the reporting configuration indicates a quota value for the network slice parameter. In such embodiments, reporting the status occurs in response to the network slice parameter reaching the quota. In certain embodiments, the received policy includes an updated quota value for the network slice parameter. In certain embodiments, the received policy for the network slice parameter includes an access control policy. In such embodiments, the processor 705 enforces access control at one or more reporting network functions in the mobile communication network.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to network slice attribute management and/or mobile operation. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the Public Land Mobile Network (“PLMN”) and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

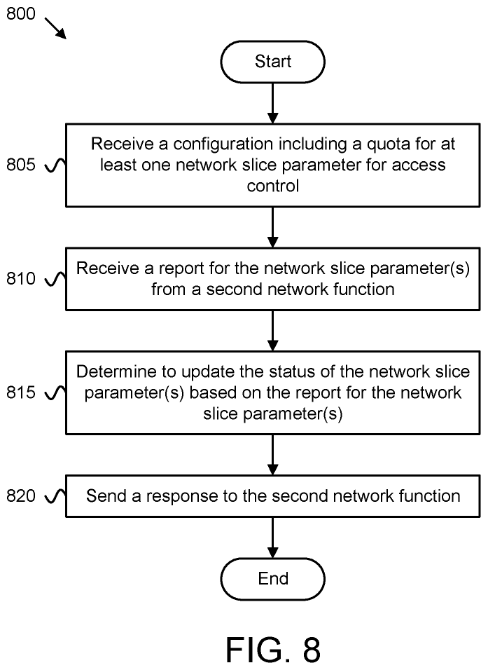

FIG. 8 depicts one embodiment of a method 800 for network slice attribute management, according to embodiments of the disclosure. In various embodiments, the method 800 is performed by a charging entity, such as the CHF 148, the CHF 205, and/or the network apparatus 700, described above as described above. In some embodiments, the method 800 is performed by a processor, such as a microcontroller, a microprocessor, a CPU, a GPU, an auxiliary processing unit, a FPGA, or the like.

The method 800 begins and receives 805 a configuration including a quota for at least one network slice parameter for access control. The method 800 includes receiving 810 a report (e.g., periodic status report or event-based notification) for the network slice parameter(s) from a second NF (e.g., QMF/NSACF). The method 800 includes determining 815 to update the status of the network slice parameter(s) based on the report for the network slice parameter(s). The method 800 includes sending 820 a response to the second NF.

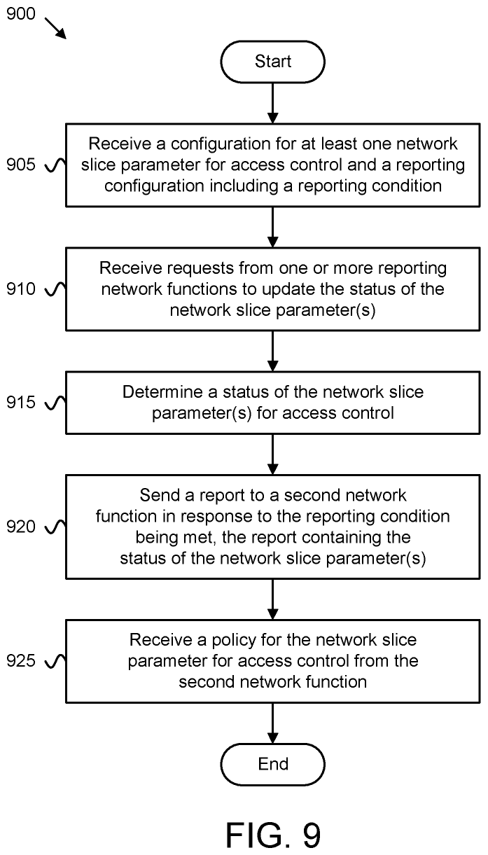

FIG. 9 depicts one embodiment of a method 900 for network slice attribute management, according to embodiments of the disclosure. In various embodiments, the method 900 is performed by a network entity, such as the QMF 145, the NSACF 210, and/or the network apparatus 700, described above as described above. In some embodiments, the method 900 is performed by a processor, such as a microcontroller, a microprocessor, a CPU, a GPU, an auxiliary processing unit, a FPGA, or the like.

The method 900 begins and receives 905 a configuration for at least one network slice parameter for access control and a reporting configuration including a reporting condition. The method 900 includes receiving 910 requests from one or more reporting network functions (e.g., AMFs or SMFs) to update the status of the network slice parameter(s). The method 900 includes determining 915 a status of the network slice parameter(s) for access control. The method 900 includes sending 920 a report to a second NF (e.g., CHF) in response to the reporting condition being met (e.g., periodic report or event-based notification), the report containing the status of the network slice parameter(s). The method 900 includes receiving 925 a policy for the network slice parameter for access control from the second NF. The method 900 ends.

Disclosed herein is a first apparatus for network slice attribute management, according to embodiments of the disclosure. The first apparatus may be implemented by a first network function for charging control, such as the CHF 148, the CHF 205, and/or the network apparatus 700, described above. The first apparatus includes a transceiver (i.e., implementing a network interface) and a processor that receives a configuration comprising a quota for a network slice parameter (i.e., at least one network slice parameter) for access control and receives a report (i.e., periodic status report or event-based notification) for the network slice parameter from a second NF (e.g., QMF/NSACF). The processor determines to update the status of the network slice parameter based on the report for the network slice parameter and sends a response to the second NF.

In some embodiments, the network slice parameter is a number of UEs currently registered with the network slice, a number of data connections (e.g., PDU Sessions or PDN Connections) currently established in the network slice, or combinations thereof. In some embodiments, the received report for the network slice parameter includes a network slice identifier and current status of the network slice parameter.

In some embodiments, the first network function is a charging function. In such embodiments, receiving the report for the network slice parameter may include receiving a slice-specific charging data request and sending the response to the second NF includes sending a charging data response which contains a policy for the network slice parameter.

In certain embodiments, the policy for the network slice parameter is determined based on the report from the second NF and the quota for the network slice parameter for access control. In certain embodiments, the received configuration contains a charging policy for a network slice instance. In such embodiments, the processor may generate a charging record (i.e., CDR) for the network slice parameter based on the received charging data request and the charging policy.

In some embodiments, the second network function includes a NSACF, and the processor determines that the quota is reached based on the received report. In such embodiments, the policy for the network slice parameter sent to the NSACF contains A) an updated quota value of the network slice parameter, or B) a policy to start/stop enforcing access control (e.g., rejecting new UEs or PDU Sessions). In certain embodiments, the processor notifies an OAM system in response to determining that the quota is reached and receives, from the OAM system, the updated quota value and/or the policy to start/stop enforcing access control.

In some embodiments, the policy for the network slice parameter includes a configuration for reporting a status of the network slice parameter, the configuration indicating the network slice parameter for admission control and a reporting granularity for reporting the status of the network slice parameter.

Disclosed herein is a first method for network slice attribute management, according to embodiments of the disclosure. The first method may be performed by a first network function for charging control, such as the CHF 148, the CHF 205, and/or the network apparatus 700, described above. The first method includes receiving a configuration that contains a quota for a network slice parameter (i.e., at least one network slice parameter) for access control and receiving a report (e.g., periodic status report or event-based notification) for the network slice parameter from a second NF (e.g., a QMF and/or NSACF). The first method includes determining to update the status of the network slice parameter based on the report for the network slice parameter and sending a response to the second NF.

In some embodiments, the network slice parameter is a number of UEs currently registered with the network slice, a number of data connections (e.g., PDU Sessions or PDN Connections) currently established in the network slice, or combinations thereof. In some embodiments, the received report for the network slice parameter includes a network slice identifier and current status of the network slice parameter.

In some embodiments, the first network function is a charging function. In such embodiments, receiving the report for the network slice parameter may include receiving a slice-specific charging data request and sending the response to the second NF includes sending a charging data response which contains a policy for the network slice parameter.

In certain embodiments, the policy for the network slice parameter is determined based on the report from the second NF and the quota for the network slice parameter for access control. In certain embodiments, the received configuration contains a charging policy for a network slice instance. In such embodiments, the first method includes generating a charging record (i.e., CDR) for the network slice parameter based on the received charging data request and the charging policy.

In some embodiments, the second network function includes a NSACF, and the first method includes determining that the quota is reached based on the received report. In such embodiments, the policy for the network slice parameter sent to the NSACF contains A) an updated quota value of the network slice parameter, or B) a policy to start/stop enforcing access control (e.g., rejecting new UEs or PDU Sessions). In certain embodiments, the first method includes notifying an OAM system in response to determining that the quota is reached and receiving, from the OAM system, the updated quota value and/or the policy to start/stop enforcing access control.

In some embodiments, the policy for the network slice parameter includes a configuration for reporting a status of the network slice parameter, the configuration indicating the network slice parameter for admission control and a reporting granularity for reporting the status of the network slice parameter.

Disclosed herein is a second apparatus for network slice attribute management, according to embodiments of the disclosure. The second apparatus may be implemented by a first network function for access control, such as the QMF 145, the NSACF 210, and/or the network apparatus 900, described above. The second apparatus includes a transceiver (i.e., implementing a network interface) and a processor that receives a configuration for a network slice parameter (i.e., at least one network slice parameter) for access control and a reporting configuration containing a reporting condition. Via the transceiver, the processor receives requests from one or more reporting network functions (e.g., AMFs or SMFs) to update the status of the network slice parameter and the processor determines a status of the network slice parameter for access control. Via the transceiver, the processor sends a report (e.g., a periodic report or an event-based notification) to a second NF (e.g., CHF) in response to the reporting condition being met, the report including the status of the network slice parameter, and receives a policy for the network slice parameter for access control from the second NF.

In some embodiments, the second network function is a charging function. In such embodiments, reporting the status of the network slice parameter includes transmitting a slice-specific charging data request. In such embodiments, receiving the policy from the second NF includes receiving a charging data response. In some embodiments, the network slice parameter includes a number of UEs currently registered with the network slice, or a number of data connections (e.g., PDU Sessions or PDN Connections) currently established in the network slice.

In some embodiments, the reporting configuration indicates a quota value for the network slice parameter. In such embodiments, reporting the status occurs in response to the network slice parameter reaching the quota. In certain embodiments, the received policy includes an updated quota value for the network slice parameter. In certain embodiments, the received policy for the network slice parameter includes an access control policy. In such embodiments, the processor enforces access control at one or more reporting network functions in the mobile communication network.

Disclosed herein is a second method for network slice attribute management, according to embodiments of the disclosure. The second method may be performed by a first network function for access control, such as the QMF 145, the NSACF 210, and/or the network apparatus 900, described above. The second method includes receiving a configuration for a network slice parameter (i.e., at least one network slice parameter) for access control and a reporting configuration containing a reporting condition. The second method includes receiving requests from one or more reporting network functions (e.g., AMFs or SMFs) to update the status of the network slice parameter and determining a status of the network slice parameter for access control. The second method includes sending a report [i.e., periodic report or event-based notification] of the network slice parameter to a second NF (e.g., CHF) in response to the reporting condition being met, the report including the status of the network slice parameter, and receiving a policy for the network slice parameter for access control from the second NF.

In some embodiments, the second network function is a charging function. In such embodiments, reporting the status of the network slice parameter includes transmitting a slice-specific charging data request. In such embodiments, receiving the policy from the second NF includes receiving a charging data response. In some embodiments, the network slice parameter includes a number of UEs currently registered with the network slice, or a number of data connections (e.g., PDU Sessions or PDN Connections) currently established in the network slice.

In some embodiments, the reporting configuration indicates a quota value for the network slice parameter. In such embodiments, reporting the status occurs in response to the network slice parameter reaching the quota. In certain embodiments, the received policy includes an updated quota value for the network slice parameter. In certain embodiments, the received policy for the network slice parameter includes an access control policy. In such embodiments, the second method further includes enforcing access control at one or more reporting network functions in the mobile communication network.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a first network function in a communication network, the method comprising:
receiving a configuration comprising a quota for a network slice parameter for access control;
receiving a report for the network slice parameter from a second network function;
determining to update the status of the network slice parameter based on the report for the network slice parameter; and
sending a response to the second network function.

2. The method of claim 1, wherein the network slice parameter comprises one of: a number of UEs currently registered with the network slice, or a number of data connections currently established in the network slice.

3. The method of claim 1, wherein the first network function comprises a charging function, wherein receiving the report for the network slice parameter comprises receiving a slice-specific charging data request and wherein sending the response to the second network function comprises sending a charging data response which contains a policy for the network slice parameter.

4. The method of claim 3, wherein the policy for the network slice parameter is determined based on the report from the second network function and the quota for the network slice parameter for access control.

5. The method of claim 3, wherein the received configuration comprises a charging policy for a network slice instance, the method further comprising generating a charging record for the network slice parameter based on the received charging data request and the charging policy.

6. The method of claim 3, wherein the second network function comprises a network slice access control function, the method further comprising determining that the quota is reached based on the received report, wherein the policy for the network slice parameter sent to the second network function contains one of:
an updated quota value of the network slice parameter, and
a policy to start/stop enforcing access control.

7. The method of claim 6, further comprising:
notifying an OAM system in response to determining that the quota is reached; and
receiving, from the OAM system, the updated quota value and/or the policy to start/stop enforcing access control.

8. The method of claim 3, wherein the policy for the network slice parameter comprises a configuration for reporting a status of the network slice parameter, the configuration indicating the network slice parameter for admission control and a reporting granularity for reporting the status of the network slice parameter.

9. The method of claim 1, wherein the received report for the network slice parameter comprises a network slice identifier and current status of the network slice parameter.

10. A first network function apparatus in a mobile communication network, the apparatus comprising:
a transceiver; and
a processor that:
receives a configuration comprising a quota for a network slice parameter for access control;
receives a report for the network slice parameter from a second network function;
determines to update the status of the network slice parameter based on the report for the network slice parameter; and
sends a response to the second network function.

11. A first network function apparatus in a mobile communication network, the apparatus comprising:
a transceiver; and
a processor that:
receives a configuration for a network slice parameter for access control and a reporting configuration comprising a reporting condition;
receives requests from one or more reporting network functions to update the status of the network slice parameter;
determines a status of the network slice parameter for access control;
sends a report comprising the status of the network slice parameter to a second network function in response to the reporting condition being met; and
receives, from the second network function, a policy for the network slice parameter for access control.

12. The apparatus of claim 11, wherein the first network function apparatus comprises a network slice access control function and the second network function comprises a charging function, wherein reporting the status of the network slice parameter comprises transmitting a slice-specific charging data request and wherein receiving the policy from the second network function comprises receiving a charging data response.

13. The apparatus of claim 11, wherein the reporting configuration indicates a quota value for the network slice parameter, wherein reporting the status occurs in response to the network slice parameter reaching the quota.

14. The apparatus of claim 13, wherein the received policy comprises an updated quota value for the network slice parameter.

15. The apparatus of claim 13, wherein the received policy for the network slice parameter comprises an access control policy, wherein the processor further enforces access control at one or more reporting network functions in the mobile communication network.
